(19) United States
(12) Patent Application Publication
(10) Pub. No.: US 2024/0193719 A1
(43) Pub. Date: Jun. 13, 2024

(54) GRAPHICS PROCESSING

(71) Applicant: Arm Limited, Cambridge (GB)

(72) Inventors: Frank Klaeboe Langtind, Melhus (NO); Andreas Due Engh-Halstvedt, Trondheim (NO)

(73) Assignee: Arm Limited, Cambridge (GB)

(21) Appl. No.: 18/517,191

(22) Filed: Nov. 22, 2023

(30) Foreign Application Priority Data
Dec. 9, 2022 (GB) 2218544.1

(51) Int. Cl. G06T 1/20; G06T 11/40

(52) U.S. Cl. CPC G06T 1/20; G06T 11/40

(57) ABSTRACT

A tiled-based graphics processor that comprises a plurality of tiling units is disclosed. The graphics processor includes an assigning circuit that assigns tiling units to process draw calls or draw call parts, and causes assigned tiling units to process draw calls or draw call parts.

### BACKGROUND

The technology described herein relates to computer graphics processing, and in particular to tile-based graphics processing.

Graphics processing is normally carried out by first dividing the graphics processing (render) output to be rendered, such as a frame to be displayed, into a number of similar basic components of geometry to allow the graphics processing operations to be more easily carried out. These basic components of geometry may often be referred to graphics “primitives”, and such primitives are usually in the form of simple polygons, such as triangles, points, lines, or groups thereof.

Each primitive (e.g. polygon) is at this stage defined by and represented as a set of vertices. Each vertex for a primitive has associated with it a set of data (such as position, colour, texture and other attributes data) representing the vertex. This “vertex data” is then used, e.g., when rasterising and rendering the primitive(s) to which the vertex relates in order to generate the desired render output of the graphics processing system.

For a given output, e.g. frame to be displayed, to be generated by the graphics processing system, there will typically be a set of vertices defined for the output in question. The primitives to be processed for the output will then be indicated as comprising given vertices in the set of vertices for the graphics processing output being generated.

Typically, the overall output, e.g. frame to be generated, will be divided into smaller units of processing, referred to as “draw calls”. Each draw call will have a respective set of vertices defined for it and respective primitives (or, generally, sets of geometry) that use those vertices. For a given frame, there may, e.g., be of the order of a few thousand draw calls, and hundreds of thousands (or potentially millions) of primitives. The draw calls for a render output, as well as the primitives within a draw call, will usually be provided in the order that they are to be processed by the graphics processing system.

Once primitives and their vertices have been generated and defined, they can be processed by the graphics processing system, in order to generate the desired graphics processing output (render output), such as a frame for display. This basically involves determining which sampling points of an array of sampling points associated with the render output area to be processed are covered by a primitive, and then determining the appearance each sampling point should have (e.g. in terms of its colour, etc.) to represent the primitive at that sampling point. These processes are commonly referred to as rasterising and rendering, respectively. (The term “rasterisation” is sometimes used to mean both primitive conversion to sample positions and rendering. However, herein “rasterisation” will be used to refer to converting primitive data to sampling point addresses only.)

One form of graphics processing uses so-called “tile-based” rendering. In tile-based rendering, the two-dimensional render output (i.e. the output of the rendering process, such as an output frame to be displayed) is rendered as a plurality of smaller area regions, usually referred to as “tiles”. In such arrangements, the render output is typically divided (by area) into regularly-sized and shaped rendering tiles (they are usually e.g., squares or rectangles).

Other terms that are commonly used for “tiling” and “tile-based” rendering include “chunking” (the rendering tiles are referred to as “chunks”) and “bucket” rendering. The terms “tile” and “tiling” will be used hereinafter for convenience, but it should be understood that these terms are intended to encompass all alternative and equivalent terms and techniques wherein the render output is rendered as a plurality of smaller area regions.

In a tile-based graphics processing pipeline, the geometry (primitives) for the render output being generated is sorted into regions of the render output area, so as to allow the geometry (primitives) that need to be processed for a given region of the render output to be identified. This sorting allows primitives that need to be processed for a given region of the render output to be identified (so as to, e.g., avoid unnecessarily rendering primitives that are not actually present in a region).

The tiling (sorting) process is typically performed by a hardware unit of the graphics processor that is provided specifically for that purpose, usually referred to as a “tiling unit” (or “tiler”). The tiling process produces lists of primitives to be rendered for different regions of the render output (commonly referred to as “primitive” or “tile” lists). In effect, each render output region can be considered to have a bin (the primitive list) into which any primitive that is found to fall within (i.e. intersect) the region is placed (and, indeed, the process of sorting the primitives on a region-by-region basis in this manner is commonly referred to as “binning”). A render output region for which a primitive list is prepared could be a single rendering tile, or a group of plural rendering tiles, etc.

Once the primitive lists have been prepared for all the render output regions, each rendering tile is processed, by rasterising and rendering the primitives listed for the rendering tile.

The Applicants believe there remains scope for improvements to tiling and tile-based graphics processors.

### BRIEF DESCRIPTION OF THE DRAWINGS

Various embodiments will now be described, by way of example only, and with reference to the accompanying drawings in which:

FIG. 1 illustrates a graphics processing system that may be operated in accordance with embodiments of the technology described herein;

FIG. 2 illustrates an exemplary tile-based graphics processor;

FIG. 3 illustrates tile-based graphics processing;

FIG. 4 illustrates a graphics processor that may be operated in accordance with embodiments of the technology described herein;

FIG. 5 illustrates a graphics processor that may be operated in accordance with embodiments of the technology described herein;

FIG. 6 illustrates a primitive list reader in accordance with embodiments of the technology described herein;

FIG. 7 illustrates a process of distributing draw calls to tiling units in accordance with embodiments of the technology described herein;

FIG. 8 illustrates a process of reading primitive lists in accordance with embodiments of the technology described herein;

FIG. 9 illustrates a process in accordance with embodiments of the technology described herein;

FIG. 10 illustrates a graphics processor that may be operated in accordance with embodiments of the technology described herein;

FIG. 11A and FIG. 11B illustrate different ways in which the graphics processor of FIG. 10 may be operated; and

FIG. 12 illustrates a graphics processor in accordance with embodiments of the technology described herein;

Like reference numerals are used for like elements in the drawings as appropriate.

### DETAILED DESCRIPTION

A first embodiment of the technology described herein comprises a tiled-based graphics processor comprising:
a plurality of tiling units; and
an assigning circuit configured to, for each of one or more draw calls and/or draw call parts to be processed to generate a render output:
   assign a tiling unit of the plurality of tiling units to process the respective draw call or draw call part; and
   cause the assigned tiling unit to process the respective draw call or draw call part.

A second embodiment of the technology described herein comprises a method of operating a tiled-based graphics processor that comprises a plurality of tiling units; the method comprising:
for each of one or more draw calls and/or draw call parts to be processed to generate a render output:
   assigning a tiling unit of the plurality of tiling units to process the respective draw call or draw call part; and
   the assigned tiling unit processing the respective draw call or draw call part.

The technology described herein is concerned with a graphics processor that has plural (in embodiments separate) tiling units. Each tiling unit should be, and in embodiments is, operable to prepare primitive lists for regions of the render output (in embodiments independently of any other tiling unit), e.g. as discussed above.

As will be discussed in more detail below, the inventors have recognised that it may be desirable to provide a graphics processor with plural tiling units, as plural tiling units can provide a greater degree of configurability as compared to typical arrangements in which a graphics processor has only one tiling unit. For example, the provision of plural tiling units may allow a graphics processor to perform a wider range of rendering tasks efficiently. For example, and in embodiments, fewer tiling units, such as only one tiling unit, may be used to perform a simpler rendering task, and more, such as all, of the tiling units may be used to perform a more complex rendering task.

In the technology described herein, for each of one or more (such as plural, in embodiments all) draw calls and/or draw call parts to be processed to generate a render output, a respective one of the tiling units of the plurality of tiling units is assigned (selected) to process, and processes, the respective draw call or draw call part. That is, in embodiments, a (each) draw call or draw call part is assigned to (only) one of the plurality of tiling units, and the assigned tiling unit is used to prepare a set of one or more primitive lists comprising the primitives of that draw call or draw call part.

For example, and in embodiments, a first tiling unit of the plurality of tiling units may be selected and used to process a first draw call or draw call part to be processed to generate the render output, and a second, different tiling unit of the plurality of tiling units may be selected and used to process a second, different draw call or draw call part to be processed to generate the same render output.

The inventors have found that this can enable plural tiling units to efficiently work together on the same rendering task. In particular, the inventors have realised that since the tiling process for a draw call (or draw call part) can be performed independently of any other draw call (or draw call part), different draw calls (and/or parts) of the same render output can be processed by different tiling units without work being duplicated by different tiling units. Furthermore, and as will be discussed in more detail below, the inventors have found that dividing a tiling task between different tiling units on the basis of draw calls can allow the processing order of draw calls, and of primitives within a draw call, to be preserved in a straightforward and efficient manner, notwithstanding the draw calls being processed separately by different tiling units.

It will be appreciated therefore, that the technology described herein provides an improved tile-based graphics processor.

The tile-based graphics processor should, and in embodiments does, generate an overall render output on a tile-by-tile basis. The render output (area) should thus be, and in embodiments is, divided into plural rendering tiles for rendering purposes.

The render output may comprise any suitable render output, such as frame for display, or render-to-texture output, etc. The render output will typically comprise an array of data elements (sampling points) (e.g. pixels), for each of which appropriate render output data (e.g. a set of colour value data) is generated by the graphics processor. The render output data may comprise colour data, for example, a set of red, green and blue, RGB values and a transparency (alpha, a) value. Where the graphics processor generates plural (e.g. a series of) render outputs, each render output may be generated in accordance with the technology described herein.

The tiles that the render output is divided into for rendering purposes can be any suitable and desired such tiles. The size and shape of the rendering tiles may normally be dictated by the tile configuration that the graphics processor is configured to use and handle.

The rendering tiles are in embodiments all the same size and shape (i.e. regularly-sized and shaped tiles are in embodiments used), although this is not essential. The tiles are in embodiments rectangular, and in embodiments square. The size and number of tiles can be selected as desired. In embodiments, each tile is 16×16, 32×32, or 64×64 data elements (sampling positions) in size (with the render output then being divided into however many such tiles as are required for the render output size and shape that is being used).

To facilitate tile-based graphics processing, the tile-based graphics processor should, and in embodiments does, include one or more tile buffers that store rendered data for a rendering tile being rendered by the tile-based graphics processor, until the tile-based graphics processor completes the rendering of the rendering tile.

The tile buffer should be, and in embodiments is, provided local to (i.e. on the same chip as) the tile-based graphics processor, for example, and in embodiments, as part of RAM that is located on (local to) the graphics processor (chip). The tile buffer may accordingly have a fixed storage capacity, for example corresponding to the data (e.g. for an array or arrays of sample values) that the tile-based graphics processor needs to store for (only) a single rendering tile until the rendering of that tile is completed.

Once a rendering tile is completed by the tile-based graphics processor, rendered data for the rendering tile should be, and in embodiments is, written out from the tile buffer to other storage that is in embodiments external to (i.e. on a different chip to) the tile-based graphics processor, such as a frame buffer in external memory, for use. The graphics processor in embodiments includes a write out circuit coupled to the tile buffer for this purpose.

The external memory could be, and in embodiments is, on a different chip to the graphics processor, and may, for example, be a main memory of the overall graphics processing system that the graphics processor is part of. It may be dedicated memory for this purpose or it may be part of a memory that is used for other data as well.

The draw calls and/or draw call parts to be processed to generate the render output can be any suitable such draw calls and/or draw call parts. A (each) draw call (part) should, and in embodiments does, comprise a set of commands to be executed by the graphics processor to generate the desired render output. In embodiments, a (each) draw call (part) comprises commands listed in the processing order in which the graphics processor should process the commands.

A draw call (part) can include any suitable commands. In embodiments, a (each) draw call (part) comprises (at least) one or more primitives to be processed to generate the render output, and an indication of the start and/or end of the draw call (part), such as a draw call start command (at the start of the list of commands) and/or a draw call end command (at the end of the list of commands).

Draw calls and/or draw call parts can be provided in any suitable manner. In embodiments, a (each) draw call is provided by a host processor that requires the render output. In embodiments, a (each) draw call is provided by a driver executing on the host processor, in embodiments in response to instructions from an application, e.g. game, executing on the host processor. Draw calls for a render output are, in embodiments, provided (by the host processor) in the processing order in which the graphics processor should process the draw calls to generate the render output.

A (each) draw call part, on the other hand, is, in embodiments, provided by splitting a draw call (provided by the host processor) into parts. Thus, in embodiments, a (each) draw call part comprises a subset of the set of commands of a draw call (provided by the host processor).

A draw call can be split into parts in any suitable manner. In embodiments, a draw call is split into parts such that the parts retain the primitive processing order of the draw call. In embodiments, a draw call is split into parts by the graphics processor (after it has been provided to the graphics processor by the host processor). Thus, in embodiments, the graphics processor includes a draw call splitting circuit that is configured to split a draw call (provided by the host processor) into plural draw call parts (and cause tiling unit(s) to be assigned to process the draw call parts). The assigning circuit and the draw call splitting circuit may comprise separate circuits, or may be at least partially formed of shared processing circuits. The draw call splitting circuit may, for example, be part of the assigning circuit.

In embodiments, the draw call splitting circuit determines whether a draw call can be split into parts, and only splits a draw call into parts when it has been determined that the draw call can be split into parts.

It can be determined that a draw call can be split into parts in any suitable manner. In embodiments, it is determined that a draw call can be split into parts when it can be certain that the resulting parts can be processed by the graphics processor independently of each other. In embodiments, it is determined that it can be certain that parts of a draw call can be processed independently of each other when the draw call does not include any commands or settings that could result in parts not being able to be processed independently of each other. For example, and in embodiments, where a draw call includes commands to draw loops, triangle fans, etc. and/or where primitive restart is enabled, it may be determined that it cannot be certain that resulting parts would be independently processable, and so in this case, the draw call may not be split.

Thus, it will be appreciated that plural draw calls for a render output may be provided to the graphics processor, none of the draw calls may be split, and the draw calls may be assigned to different tiling units of the graphics processor for processing. Alternatively, plural draw calls for a render output may be provided to the graphics processor, only some of the draw calls may be split into draw call parts, and the draw call parts and the draw call(s) that have not been split may be assigned to different tiling units of the graphics processor for processing. Alternatively, plural draw calls for a render output may be provided to the graphics processor, all of the draw calls may be split into draw call parts, and the draw call parts may be assigned to different tiling units of the graphics processor for processing. Alternatively, only one draw call for a render output may be provided to the graphics processor, the draw call may be split into draw call parts, and the draw call parts may be assigned to different tiling units of the graphics processor for processing.

In embodiments, the graphics processor comprises a command receiving circuit (e.g. command stream frontend) configured to receive draw calls from the host processor (and provide draw calls to the assigning circuit and/or draw call splitting circuit). In embodiments, a (each) draw call is written to the (external) memory by (the driver executing on) the host processor, and is read therefrom by the (command receiving circuit of the) graphics processor. The assigning circuit and the command receiving circuit may comprise separate circuits, or may be at least partially formed of shared processing circuits. The assigning circuit may, for example, be part of the command receiving circuit.

Where the assigning circuit is separate to the command receiving circuit, the assigning circuit may be configured to communicate with the command receiving circuit as if it were a tiling unit, e.g. such that the command receiving circuit can interact with the assigning circuit in substantially the same way that it would interact with the tiling unit of a graphics processor that has only one tiling unit.

In other embodiments, the assigning circuit is part of one of the tiling units. In this case, the tiling unit that comprises the assigning circuit may operate as a master tiling unit, and the other tiling unit(s) may operate as slave tiling units. For example, (only) the master tiling unit may communicate (directly) with the command receiving circuit, and the master tiling unit may distribute draw calls and/or draw call parts to slave tiling unit(s).

In the technology described herein, for a (each) draw call (part), one of the tiling units is assigned (selected) to process, and processes (prepares primitive lists for), the draw call (part). In embodiments, the assigning circuit of the graphics processor receives the draw call(s) to be processed (from the command receiving circuit), the draw call splitting circuit optionally splits received draw call(s) into draw call parts, and the assigning circuit assigns a tiling unit to process a (each) draw call (part), and passes the draw call (part) to the assigned tiling unit for processing.

The assigning circuit is, in embodiments, operable to assign different tiling units to process different draw calls and/or draw call parts for the same render output, e.g. so as to share the processing requirements for the render output between the different tiling units. To facilitate this, in embodiments, tiling units are assigned to process draw calls and/or draw call parts (by the assigning circuit) in accordance with a scheduling scheme. The assigning circuit should thus be, and in embodiments is, operable as a scheduler.

The scheduling scheme can be any suitable scheduling scheme, e.g. that attempts to achieve load balancing between the different tiling units. For example, the scheduling scheme may be round-robin, first come first serve, etc.

For example, and in embodiments, the tiling units are assigned in a sequence, e.g. with a first tiling unit in the sequence being assigned to process a first draw call (part), the next tiling unit in the sequence being assigned to process the next draw call (part), and so on. Once a last tiling unit in the sequence has been assigned, the first tiling unit in the sequence may be assigned again to process the next draw call (part), and so on.

Alternatively, in embodiments, the assigning circuit may attempt to assign a tiling unit that is not (currently) processing a draw call (part), and if all of the tiling units are (currently) processing a draw call (part), the assigning circuit may assign the first tiling unit to complete its processing. Other arrangements are possible.

Once a draw call or draw call part has been provided to a tiling unit for processing (by the assigning circuit), the tiling unit should, and in embodiments does, process (prepare primitive lists for) (the entirety of) that draw call or draw call part. Thus a (each) tiling unit, in embodiments, prepares a respective set of primitive lists for all of the primitives of a (each) draw call (part) assigned to it for processing.

A (each) tiling unit should be, and in embodiments is, operable to prepare a set of primitive lists for respective regions of the render output for a draw call or draw call part provided to it for processing (by the assigning circuit). That is, a (each) tiling unit should be, and in embodiments is, operable to sort geometry to be processed to generate a render output into primitive listing regions that the render output is divided into. The regions of the render output that a tiling unit can prepare primitive lists for may correspond e.g. to single rendering tiles, or to sets of plural rendering tiles (e.g. in the case of “hierarchical tiling” arrangements).

In embodiments, each draw call or draw call part is processed by a tiling unit such that the order of the primitives within the input draw call or draw call part is maintained in (e.g. can be determined when processing) the resulting output set of primitive lists. In embodiments, a (each) tiling unit writes out a (each) set of primitive lists it has prepared to the (external) memory.

In embodiments, a (each) tiling unit is a hardware unit of the graphics processor. The tiling units may comprise separate circuits, or may be at least partially formed of shared processing circuits.

In embodiments, a (each) tiling unit is selectively activatable. Thus, for example, and in embodiments, more tiling units may be activated when processing a relatively more complex render output, and fewer tiling units may be activated when processing a relatively less complex output.

The graphics processor can include any suitable number of plural tiling units, such as two, three, four, or more. All of the tiling units may be substantially the same as each other, or some or all of the tiling units may be different to each other.

For example, and in embodiments, all of the tiling units may have the same processing capacity as each other (in other words, the maximum rate at which a tiling unit can prepare primitive lists may be the same for all of the tiling units (for a given set of input data)), or there may be tiling units that have different processing capacities (different maximum rates at which primitive lists can be prepared (for a given set of input data)). For example, tiling units may have the same or different memory capacities, e.g. the same or different sized buffers. The distribution of processing capacities may be selected as desired, for example, and in embodiments, as discussed in WO 2022/096879, the entire contents of which is hereby incorporated herein by reference.

Where tiling units have different processing (e.g. memory) capacities, the different processing capacities may be taken into account when assigning tiling units to process draw calls and/or draw call parts. For example, a higher processing capacity tiling unit may be preferentially selected (by the assigning circuit) to process a relatively more complex draw call (part) (e.g. a draw call (part) that comprises more primitives and/or vertices), and/or more draw calls and/or draw call parts may be assigned (by the assigning circuit) to a higher processing capacity tiling unit than to a lower processing capacity tiling unit.

In embodiments of the technology described herein, different (separate) sets of primitive lists are prepared by different tiling units for the same render output. In embodiments, the graphics processor therefore needs to be able to process different sets of primitive lists prepared by different tiling units in order to generate the render output. This can be achieved in any suitable manner.

In embodiments, the graphics processor comprises a rendering circuit that processes primitives to generate rendering tiles of the render output, and a primitive providing circuit (e.g. primitive list reader) that provides to the rendering circuit the primitives that the rendering circuit needs to process to generate a rendering tile. In embodiments, the primitive providing circuit selects primitives listed in primitive lists that need to be processed by the rendering circuit to generate a rendering tile, and provides the selected primitives to the rendering circuit in the order in which the rendering circuit should process the primitives. In embodiments, the rendering circuit processes primitives provided to it by the primitive providing circuit in the order in which the primitive providing circuit provides them.

The rendering circuit may include a rasteriser and a fragment renderer. In embodiments, the rasteriser receives primitives from the primitive providing circuit (e.g. primitive list reader), rasterises the primitives to fragments, and provides the fragments to the fragment renderer for processing. In embodiments, the fragment renderer is operable to perform fragment rendering to generate rendered fragment data, and may perform any appropriate fragment processing operations in respect of fragments generated by the rasteriser, such as texture mapping, blending, shading, etc. In embodiments, rendered fragment data generated by the fragment renderer is written to a tile buffer. Other arrangements are possible.

In this case, in embodiments, the primitive providing circuit (e.g. primitive list reader) is configured to be able to read (from the (external) memory) primitive lists prepared by each of the plurality of tiling units. Thus, in embodiments, the processing of different sets of primitive lists prepared by different tiling units is facilitated by there being a single primitive list reader that can read primitive lists prepared by plural different tiling units.

The primitive providing circuit (e.g. primitive list reader) may, for example and in embodiments, comprise a plurality of primitive list fetchers, wherein different primitive list fetchers of the plurality of primitive list fetchers are configured to fetch primitives (for a rendering tile) from primitive lists (from the (external) memory) prepared by different tiling units. The primitive providing circuit may, for example and in embodiments, comprise a set of one or more primitive list fetchers for each tiling unit of the plurality of tiling units.

A (each) set of primitive list fetchers may, for example and in embodiments, comprise only one primitive list fetcher (e.g. in the case where primitive lists are prepared only for single rendering tiles), or plural primitive list fetchers, e.g. one per hierarchy level in the case of hierarchical tiling.

Where there are plural primitive list fetchers in a set of primitive list fetchers, the primitive providing circuit (e.g. primitive list reader) may further comprise, for each set of primitive list fetchers, a respective primitive list merging circuit configured to merge the outputs of each of the plural primitive list fetchers in the respective set of primitive list fetchers. The merging may be done so as to maintain primitive processing order. Other arrangements are possible.

In embodiments, the primitive providing circuit (e.g. primitive list reader) provides (to the rendering circuit) all of the primitives that need to be processed to generate a rendering tile from one set of primitive lists (prepared by a tiling unit processing one draw call or draw call part) before providing (to the rendering circuit) any primitives that need to be processed to generate the rendering tile from another set of primitive lists (prepared by a tiling unit processing another draw call or draw call part). The primitive providing circuit (e.g. primitive list reader) thus provides (to the rendering circuit) primitives to be processed to generate a rendering tile, one draw call (or draw call part) at a time. This can then allow the primitive order within each draw call or draw call part to be maintained.

This can be facilitated in any suitable and desired manner. In embodiments, the primitive providing circuit (e.g. primitive list reader) comprises a selecting circuit that can select primitives from primitive lists prepared by each of the plurality of tiling units. In embodiments, the selecting circuit is configured to select primitives from primitive lists prepared by (only) one of the plurality of tiling units at a time.

The selecting circuit is, in embodiments, configured to only select primitives from primitive lists prepared by a different tiling unit at a draw call (part) boundary. To do this, in embodiments, the selecting circuit is configured to determine whether it should switch to selecting primitives from primitive lists prepared a different tiling unit in response to an indication of the end of a current draw call or draw call part (e.g. a draw call end command), or the start of a new draw call or draw call part (e.g. a draw call start command).

Furthermore, in embodiments, the primitive providing circuit (e.g. primitive list reader) provides primitives (to the rendering circuit) so as to maintain the draw call (part) processing order of draw calls and/or draw call parts (that were processed to prepare the sets of primitive lists). This can be achieved in any suitable and desired manner.

In embodiments, each draw call (part) to be processed to generate the render output is assigned (by the assigning circuit) an identifier indicating a draw call (part) processing order in which the respective draw call (part) should be processed to generate the render output. The assigned identifiers are then, in embodiments, used by the primitive providing circuit (e.g. primitive list reader) to provide primitives to the rendering circuit in accordance with the draw call (part) processing order.

The identifiers can take any suitable form. In embodiments, an identifier comprises an integer that starts from an initial value (such as zero) for a first draw call (part) for a render output, and is incremented (such as by one) for each subsequent draw call (part) for the same render output. Other arrangements would be possible.

In embodiments, the assigning circuit passes the identifier assigned to a draw call (part) to the assigned tiling unit together with the draw call (part) for processing. In embodiments, a (each) tiling unit outputs (to the (external) memory) the identifier assigned to a draw call (part) together with a set of primitive lists it has prepared for the draw call (part). In embodiments, the primitive providing circuit (e.g. primitive list reader) reads primitive lists and identifiers output by the plurality of tiling units, and uses read identifiers to merge read primitive lists in accordance with the draw call (part) processing order.

In embodiments, the selecting circuit uses the identifiers to merge primitive lists. Thus, in embodiments, the selecting circuit is configured to, in response to an indication of the end of a current draw call or draw call part (e.g. a draw call end command) or the start of a new draw call or draw call part (e.g. draw call start command), compare identifiers (assigned by the assigning circuit) associated with sets of primitive lists prepared by the plurality of tiling units, and select primitives from a set of primitive lists prepared by one of the plurality of tiling units based on the comparison. In embodiments, the selecting circuit selects the tiling unit output associated with the identifier indicating the next draw call (part) in the draw call (part) processing order, e.g. the (next) lowest identifier.

The graphics processor can be any suitable graphics processor that has plural tiling units. The graphics processor may, for example, be a “partitionable” graphics processor that includes plural combinable graphics processing units, e.g. substantially as described in WO 2022/096879.

Thus, the graphics processor may comprise a plurality of graphics processing units, wherein one or more of the graphics processing units are operable in combination with at least one other graphics processing unit of the plurality of graphics processing units; and a control circuit configured to: partition the plurality of graphics processing units into one or more sets of one or more graphics processing units, wherein each set of one or more graphics processing units is operable to generate a render output independently of any other set of one or more graphics processing units of the one or more sets of one or more graphics processing units; and cause one or more tiling units of the plurality of tiling units to operate in combination with each set of one or more graphics processing units when generating a render output.

In this case, plural, such as all, of the graphics processing units may comprise a respective one of the plurality of tiling units. Thus, for example, plural tiling units may operate in combination in the same partition. One or more, such as plural, such as all, of the graphics processing units may comprise a respective assigning circuit. Thus, the graphics processor may comprise only one or plural assigning circuits, each of which may be operable as discussed above.

Other arrangements are possible. For example, the graphics processor may not be partitionable, or may not comprise plural combinable graphics processing units.

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the graphics processing system may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) execution unit of) the processor.

The processor may also comprise, and/or be in communication with, one or more memories and/or memory devices that store the data described herein, and/or store software (e.g. (shader) program) for performing the processes described herein. The processor may also be in communication with a host microprocessor, and/or with a display for displaying images based on data generated by the processor.

The technology described herein can be used for all forms of input and/or output that a graphics processor may use or generate. For example, the graphics processor may execute a graphics processing pipeline that generates frames for display, render-to-texture outputs, etc. The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the data processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc. . . .

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

As discussed above, in embodiments of the technology described herein, different draw calls of a render output are assigned to different tiling units for processing.

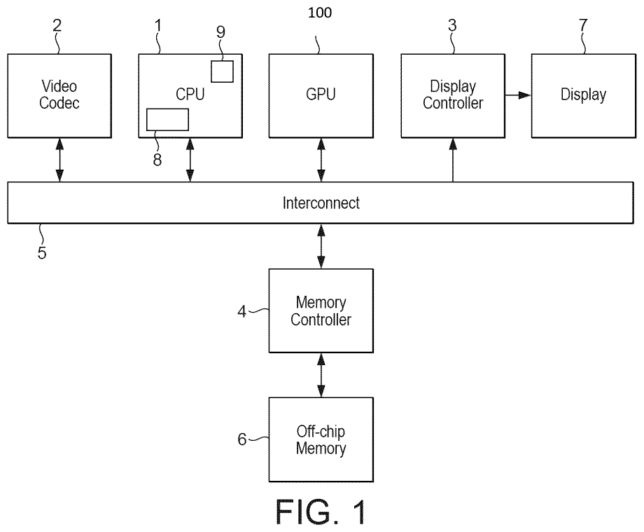

FIG. 1 shows an exemplary graphics processing system in which the embodiments of technology described herein may be implemented.

The exemplary graphics processing system shown in FIG. 1 comprises a host processor comprising at least one central processing unit (CPU) 1, a graphics processor (graphics processing unit (GPU)) 100, a video codec 2, a display controller 3, and a memory controller 4. As shown in FIG. 1, these units communicate via an interconnect 5 and have access to an off-chip memory system (memory) 6. In this system, the graphics processor 100, the video codec 2 and/or CPU 1 will generate frames (images) to be displayed and the display controller 3 will then provide frames to a display 7 for display.

In use of this system, an application 8, such as a game, executing on the host processor (CPU) 1 will, for example, require the display of frames on the display 7. To do this the application 8 will send appropriate commands and data to a driver 9 for the graphics processor 100 that is executing on the at least one CPU 1. The driver 9 will then generate appropriate commands and data to cause the graphics processor 100 to render appropriate frames for display and store those frames in appropriate frame buffers, e.g. in main memory 6. The display controller 3 will then read those frames into a buffer for the display from where they are then read out and displayed on the display panel of the display 7.

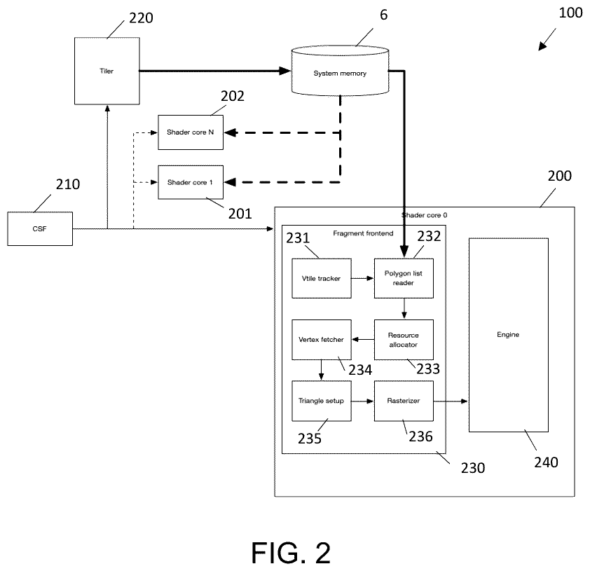

FIG. 2 shows the graphics processor 100 in more detail. FIG. 2 shows the main elements of the graphics processor 100 that are relevant to the operation of the present embodiments. As will be appreciated by those skilled in the art, there may be other elements of the graphics processor that are not illustrated in FIG. 2. It should also be noted that FIG. 2 is only schematic, and that, for example, in practice the shown functional units and pipeline stages may share significant hardware circuits, even though they are shown schematically as separate stages in FIG. 2.

As shown in FIG. 2, the tile-based graphics processor 100 includes a command stream frontend (CSF) 210, a tiler 220, and a set of shader cores 200, 201, 202. FIG. 2 shows three shader cores, but other numbers of shader cores are possible. FIG. 2 illustrates one of the shader cores 200 in greater detail than the others 201, 202, but it will be appreciated that each shader core of the graphics processor 100 may have substantially the same configuration.

The command stream frontend 210 receives commands and data from the driver 9 (directly, or via data structures in memory), and distributes subtasks for execution to the tiling unit 220 and to the shader cores 200, 201, 202 appropriately.

The graphics processor 100 of FIG. 2 is a tile-based graphics processor. In a tile-based rendering system the render output (e.g. frame for display) is divided into a plurality of tiles for rendering. Typically, each tile is 16×16, 32×32, or 64×64 data elements (sampling positions) in size, with the render output being divided into however many such tiles as are required for the render output size and shape that is being used. The tiles are rendered separately to generate the render output. To do this, for each draw call that is received to be processed, it is first necessary to sort the primitives (polygons) for the draw call according to which tiles they should be processed for.

In order to facilitate this, the tiling unit 220 is operable to perform a first processing pass in which lists of primitives to be processed for different regions of the render output are prepared. These “primitive lists” (which can also be referred to as a “tile list” or “polygon list”) identify the primitives to be processed for the region in question.

The tiling unit 220 of FIG. 2 is a hierarchical tiler. Thus, as well as the render output being divided into tiles for rendering purposes, the render output is also, in effect, divided into plural sets of progressively larger sub-regions for which separate (different) primitive lists can be and are prepared by the tiling unit 220. The render output is, in effect, overlaid with a progressively increasing hierarchy of render output sub-divisions that the tiling unit 220 can prepare primitive lists for.

In the present example, the tiling unit 220 lists a primitive at only one level of the hierarchy, and selects the hierarchy level at which to list primitives so as to (try to) minimise the number of primitive reads and writes that would be required to render the primitives. Other arrangements are possible. For example, a primitive may be listed at plural levels of the hierarchy. Alternatively, the tiler may be non-hierarchical, and thus may prepare primitives lists only for individual rendering tiles.

As part of this processing pass, the tiler 220 and/or command stream frontend (CSF) 210 may request vertex processing tasks to be performed by the set of shader cores 200, 201, 202 to generate processed (transformed) vertex data that the tiling unit 220 uses to prepare primitive lists. This “vertex shading” operation may comprise, for example, transforming vertex position attributes from the model space that they are initially defined for to the screen space that the output of the graphics processing is to be displayed in.

Once all of the vertex processing and tiling has been completed, the transformed geometry and the primitive lists are written back to the main memory 6, and the first processing pass is complete.

A second processing pass is then performed for the render output, wherein each of the rendering tiles is rendered separately.

In this processing pass, the fragment frontend 230 of a shader core 200 receives fragment processing tasks from the command stream frontend (CSF) 210, and in response, tile tracker 231 schedules the rendering work that the shader core needs to perform in order to generate a tile. Primitive list reader 232 then reads the appropriate primitive list(s) for that tile from the memory 6 to identify the primitives that are to be rendered for the tile.

Resource allocator 233 then configures various elements of the graphics processor 100 for rendering the primitives that the primitive list reader 232 has identified are to be rendered for the tile. For example, the resource allocator 233 may appropriately configure a local tile buffer for storing output data for the tile being rendered.

Vertex fetcher 234 then reads the appropriate processed (transformed) vertex data for primitives to be rendered from the memory 6, and provides the primitives (i.e. their processed vertex data) to triangle set-up unit 235. The triangle set-up unit 235 performs primitive setup operations to setup the primitives to be rendered. This includes determining, from the vertices for the primitives, edge information representing the primitive edges. The edge information for the primitives is then passed to the rasteriser 236.

When the rasteriser 236 receives a graphics primitive for rendering (i.e. including its edge information), it rasterises the primitive to sampling points and generates one or more graphics fragments having appropriate positions (representing appropriate sampling positions) for rendering the primitive.

Fragments generated by the rasteriser 236 may then be subject to “culling” operations, such as depth testing, to see if any fragments can be discarded (culled) at this stage. Execution threads are then issued to execution engine 240 for processing fragments that have survived the culling stage.

The execution engine 240 executes a shader program for each execution thread issued to it to generate appropriate render output data, including colour (red, green and blue, RGB) and transparency (alpha, a) data. The rendering engine 240 may perform fragment processing (rendering) operations such as texture mapping, blending, shading, etc. on the fragments. Output data generated by the execution engine 240 is then written appropriately to the tile buffer.

Once a tile has been processed, its data is exported from the tile buffer to the main memory 6 (e.g. to a frame buffer in the main memory 6) for storage, and the next tile is then processed, and so on, until sufficient tiles have been processed to generate the entire render output (e.g. frame (image) to be displayed). The next render output (e.g. frame) may then be generated, and so on.

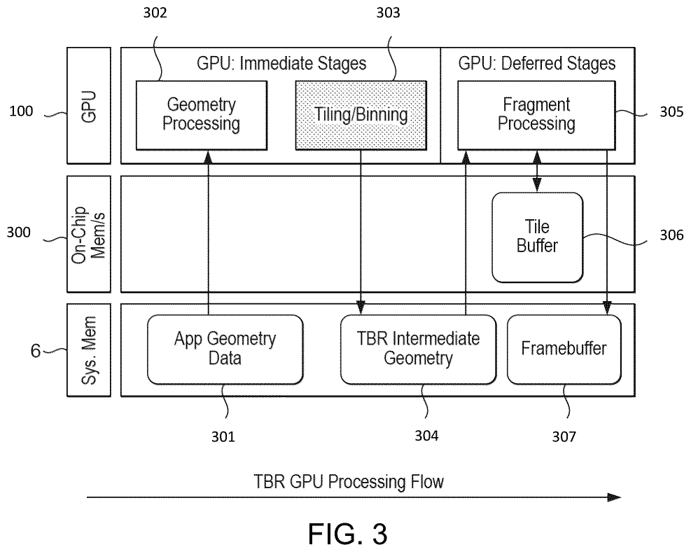

FIG. 3 shows schematically the tile-based rendering process. As shown in FIG. 3, in the first processing pass, the required geometry data 301 for a draw call is read from the external memory system 6 into the graphics processor 100. The primitive vertices are thus obtained and the geometry processing 302 (vertex shading) is performed in order to generate a corresponding set of post-transformed geometry data (e.g. transformed vertices) 304.

The transformed geometry is subject to a tiling operation 303 by the tiling unit 220 of the graphics processor 100, wherein it is determined for each of the primitives which rendering tiles the primitives should be processed for. The tiling unit may also operate to cull primitives that are outside of the view frustrum, or are back facing. In this way, respective primitive lists are generated that indicate which primitives are to be rendered for which of the rendering tiles.

Once all of the geometry processing for the render output has completed, and the tiling operating has completed, the transformed geometry 304 is written back to the external memory system 6 together with the primitive lists, and the first processing pass is complete.

The second processing pass is then performed wherein each of the rendering tiles is rendered (separately) in turn. Thus, for each rendering tile, it is determined from the respective primitive list(s) which primitives should be processed for that tile, and the associated transformed geometry data 304 for those primitives is read back in from memory 6 and subject to fragment processing 305 to generate the render output.

As shown in FIG. 3, the rendering is performed using a tile buffer 306 that resides in on-chip memory 300. Thus, the rendering of a given tile is performed locally to the graphics processor 100. Once the rendering for the tile has complete, the rendered data is then written out to the external memory 6, e.g. into a frame buffer 307, e.g. for display.

It has been recognised that as desired rendering tasks become larger and more complex, the tiling process performed by the tiling unit 220 becomes correspondingly more complex. Similarly, as desired frame rates increase, the time available to complete the tiling process decreases. One way of dealing with increasing demands on the tiling unit is to increase its size (i.e. processing capacity). However, the inventors have recognised that this can result in a reduction in the efficiency with which smaller tile-based rendering tasks are performed.

In embodiments of the technology described herein, a graphics processor is provided with a plurality of separate tiling units. Each of the tiling units may be selectively activatable, and can operate in combination with one or more of the other tiling units to prepare primitive lists, such that, for example, only one or some of the tiling units can operate to perform a relatively simple rendering task, and more, such as all, of the tiling units can operate together to perform a more complex rendering task. This can then allow the graphics processor to efficiently handle both complex and simple tile-based rendering tasks.

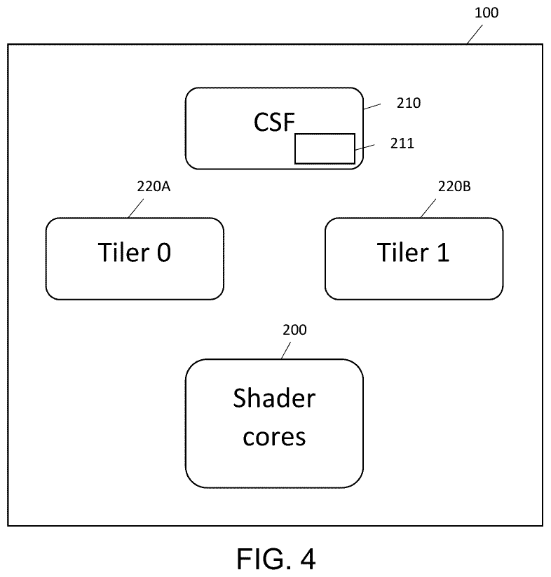

FIG. 4 illustrates a graphics processor 100 according to an embodiment that includes two tiling units 220A, 220B. More than two tiling units would be possible. In this embodiment, command stream frontend (CSF) 210 can either activate only one of the tiling units 220A, 220B to operate by itself to prepare primitive lists for a render output (e.g. frame for display), or activate both of the tiling units 220A, 220B to operate together to prepare primitive lists for the same render output (e.g. frame for display).

To facilitate this, as shown in FIG. 4, the command stream frontend (CSF) 210 includes a tiler iterator 211 (assigning circuit) that can distribute tiling tasks to the plural tiling units 220A, 220B. Although FIG. 4 shows tiler iterator 211 as being part of the command stream frontend (CSF) 210, in other embodiments, the tiler iterator 211 is a separate processing unit of the graphics processor 100. In this case, the tiler iterator 211 may, for example, appear to, and interact with, the command stream frontend (CSF) 210 as if it were a tiling unit. In other embodiments, the tiler iterator 211 is part of a master tiling unit that can distribute tasks to one or more slave tiling units.

The inventors have realised that one problem that arises when plural tiling units operate in combination to prepare primitive lists for the same render output (e.g. frame) is ensuring that primitives are subsequently rendered in the correct order, i.e. in the order originally specified by the application 8. As discussed above, an application 8 will usually specify plural draw calls for a render output in an order in which the draw calls should be processed. Furthermore, the application 8 will usually specify the primitives within each draw call in the order in which the primitives should be rendered.

In embodiments of the technology described herein, the tiler iterator 211 splits tiling tasks for a render output (e.g. frame) between different tiling units on the basis of draw calls. Thus, for example, when a first draw call for the render output is received for processing, the tiler iterator 211 assigns it to one of the tiling units 220A, 220B, and then when the next draw call for the render output is received for processing, the tiler iterator 211 assigns it to the other of the tiling units 220A, 220B, and so on. The tiler iterator 211 may thus assign draw calls to tiling units in a round robin fashion. However, other scheduling schemes, such as first come first serve, are possible.

This avoids the duplication of work by different tiling units. Furthermore, in embodiments, all of the primitives of any given draw call are processed by the same tiling unit, and in the order specified by the draw call. This means that the order of the primitives within a draw call can be preserved in the resulting primitive lists.

Furthermore, in embodiments, when the tiler iterator 211 receives a draw call for processing, it encodes information indicating the order in which it received the draw call, and passes this information onwards to a tiling unit together with the draw call.

In the present embodiment, the tiler iterator 211 encodes a draw call sequence number that starts at zero for a first draw call of a render output (e.g. frame), and increases by one for each subsequent draw call for that render output. Other encoding schemes would be possible.

Each tiling unit outputs the draw call sequence number of a draw call it has processed together with the resulting primitive lists, and the draw call sequence numbers are then used by the primitive list reader 232 to reconstruct the original order of draw calls.

Thus, in effect, each tiling unit produces a set of primitive lists for one or more draw calls assigned to it, and the polygon list reader 232 uses draw call sequence numbers to perform a “merge-sort” operation to combine the different sets of primitives lists from the different tiling units in the desired order.

The inventors have found that this can allow multiple tilers to cooperate to generate the same render output, while preserving the order of draw calls, and of primitives within a draw call, in a particularly straightforward and efficient manner.

The inventors have furthermore realised that where a draw call is split into two or more parts, the order of the draw call parts can be preserved in substantially the same manner, i.e. by assigning sequence numbers to draw call parts prior to the tiling stage, assigning each draw call part to one of the tiling units (such that only one of the tiling units processes all of the primitives in any given draw call part), and using the sequence numbers to reconstruct the original draw call part order at the primitive list reading stage.

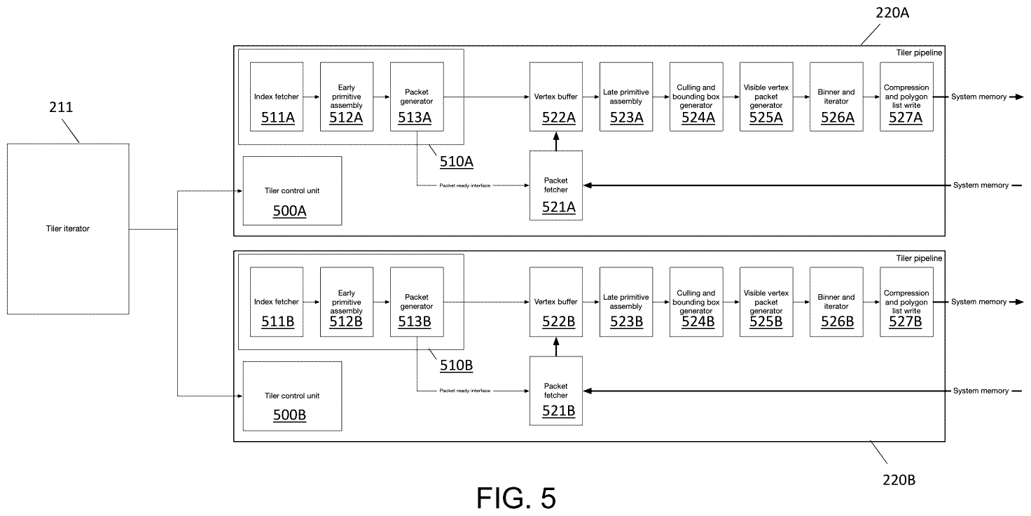

FIG. 5 illustrates the graphics processor of the present embodiment in more detail. As illustrated in FIG. 5, for each draw call (or draw call part), the tiler iterator 211 assigns a respective sequence number to the draw call (or draw call part), assigns one of two different tiling units 220A, 220B to process the draw call (or draw call part), and passes the draw call (or draw call part) to the assigned tiling unit for processing together with the assigned sequence number. Each tiling unit has a control unit 500A, 500B that receives assigned tiling tasks from the tiler iterator 211, and controls a tiler pipeline of the tiling unit to perform the requested tasks.

As shown in FIG. 5, in the present embodiment, each tiling pipeline includes an early primitive assembly circuit/process 510A, 510B that triggers vertex position shading operations. Each early primitive assembly circuit 510A, 510B includes an index fetcher 511A, 511B that fetches and outputs a sequence (stream) of indices from a stored vertex index array defined and provided for the render output being generated, and provides the sequence of indices to early primitive assembly stage 512A, 512B, which assembles complete primitives from the stream of indices, and provides a sequence of complete assembled primitives to packet generation stage 513A, 513B, which generates vertex packets comprising vertices of assembled primitives.

Each vertex packet has a maximum permitted capacity of vertices, such as 64 vertices, and once that capacity is reached, a new vertex packet is started. In the present embodiment, once a vertex packet has been filled up, the packet generator 513A, 513B triggers vertex shading of position attributes for the vertices that have been included in the vertex packet. The position shading for a vertex packet is performed by the shader cores 200 executing an appropriate shader program, and generates and stores in memory 6 a vertex packet comprising the vertex shaded (transformed) positions for the vertices of the vertex packet.

Then, as shown in FIG. 5, packet fetcher 521A, 521B loads vertex packets (when they are ready) from memory 6 into a vertex buffer 522A, 522B, and late primitive assembly stage 523A, 523B adds the transformed positions to the assembled primitives output by the early primitive assembly stage 512A, 512B, and provides the so assembled primitives to subsequent stages of the tiling process.

Thus, bounding box generation stage 524A, 524B generates appropriate bounding boxes for the assembled primitives, and also operates to identify any primitives that can be culled from further processing on the basis of their (potential) visibility. The primitives with their bounding boxes are then passed to visible vertex packet generation stage 525A, 525B which triggers vertex attribute processing (vertex shading) for any remaining (non position) attributes (varyings) of vertices belonging to primitives that have passed the culling process. Again, this further vertex shading is performed by the shader cores 200 executing an appropriate shader program, and the processed other vertex attributes (varyings) are added appropriately to the generated vertex packets.

The primitives with their bounding boxes are then passed to the binning and hierarchical iteration stage 526A, 526B, which operates to identify using the bounding boxes for the primitives which primitive lists the primitives should be listed in, and outputs the primitive lists.

Finally, compression and write stage 527A, 527B compresses the primitives lists generated for a draw call (or draw call part), and writes them to memory 6 together with the sequence number assigned to the draw call (or draw call part) by the tiler iterator 211. Other arrangements are possible.

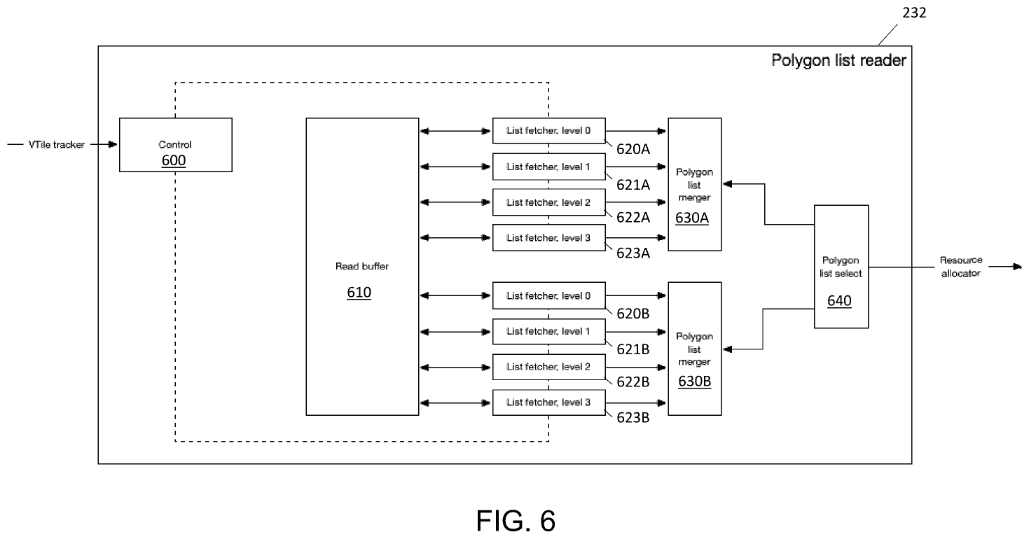

FIG. 6 illustrates the primitive list reader 232 in accordance with the present embodiment. As shown in FIG. 6, the primitive list reader 232 has a control unit 600 that receives tasks from the tile tracker 231, and controls the primitive list reader 232 to read primitive lists from memory 6 into a local buffer 610. The primitive list reader 232 reads in primitive lists for a draw call (or draw call part), together with the sequence number for the draw call (or draw call part).

In the present embodiment, the tilers 220A, 220B are hierarchical tilers that each prepare primitive lists for four hierarchy levels, and the primitive list reader 232 correspondingly includes a respective set of four list fetchers for each of the two tilers 220A, 220B. Thus, there is a first set of list fetchers 620A-623A that fetch primitive lists prepared by the first tiler 220A, and a second set of list fetchers 620B-623B that fetch primitive lists prepared by the second tiler 220B. Each list fetcher fetches from memory 6 the primitives list(s) relevant to the current rendering tile for a respective one of the hierarchy levels. Other arrangements are possible. For example, non-hierarchical tilers may be used, in which case the primitive list reader 232 may have only one fetcher per tiler.

As shown in FIG. 6, the primitive list reader 232 further includes a respective primitive list merger 630A, 630B corresponding to each of the two tilers 220A, 220B. Each primitive list merger 630A, 630B operates to merge the primitive lists for the different hierarchy levels into a single list of primitives to be processed for the current rendering tile, and the merging is done so as to preserve the order in which the primitives were originally specified (within the draw call (or draw call part)).

The primitive list mergers 630A, 630B also keep track of the respective sequence numbers. Thus, each primitive list merger 630A, 630B outputs a list of primitives of a draw call (or draw call part) to be processed for the current rendering tile in the order in which the primitives should be processed, together with the sequence number for the draw call (or draw call part). It will be appreciated that in embodiments with non-hierarchical tilers, primitive list mergers may be omitted.

As shown in FIG. 6, the primitive list reader 232 further includes a primitive list selector 640. The primitive list selector 640 selects the output of either the first primitive list merger 630A or the second primitive list merger 630B, and passes the selected output onwards to the resource allocator 233 for processing.

When the primitive list selector 640 encounters a begin draw call command, it compares the sequence numbers indicated by the primitive list mergers 630A, 630B, and selects the output of the primitive list merger 630A, 630B that has the lowest sequence number. The primitive list selector 640 thus only switches to the output of a different primitive list merger at a draw call (or draw call part) boundary, and maintains the desired order by selecting the lowest sequence number.

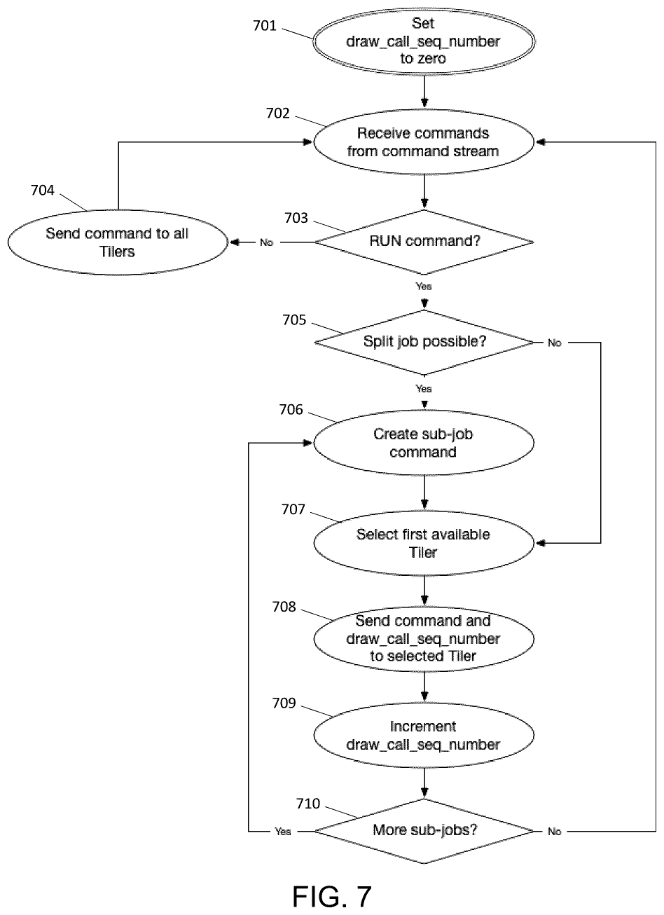

FIG. 7 illustrates a process performed by the tiler iterator 211 in accordance with embodiments of the technology described herein.

As shown in FIG. 7, when a new frame is to be processed, the sequence number is initially set to zero (at step 701). The tiler iterator 211 receives commands from the command stream (at step 702), and determines (at step 703) when a RUN draw call command is received.

As shown in FIG. 7, the tiler iterator 211 sends commands other than those relating to a draw call to all of the tiling units (at step 704). When, however, a RUN draw call command is received, it is first determined (at step 705) whether or not the draw call to be processed should be split into multiple parts, and if so, the draw call is split (at step 706). A draw call may be split at a primitive boundary, but where it is difficult to determine primitive boundaries, e.g. in the case of drawing loops, triangle fans, and where primitive restart is enabled, etc., a draw call may not be split.

The next available tiling unit is then determined (at step 707), and the draw call (or draw call part) is sent to that tiler for processing, together with the current value of the sequence number (at step 708). The sequence number is then incremented (at step 709). If (at step 710) the draw call has been split into multiple parts, the process is repeated appropriately for each draw call part.

Then once the draw call (or all of the parts of the draw call) have been processed in this manner, the tiler iterator 211 returns to monitoring for a new draw call (at step 702), and so on.

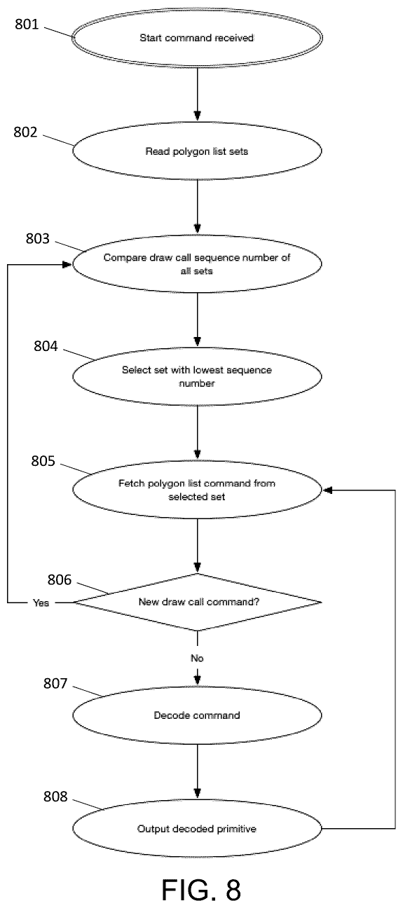

FIG. 8 illustrates a corresponding process performed by the primitive list reader 232 in accordance with embodiments of the technology described herein.

As shown in FIG. 8, when the primitive list reader 232 receives a start frame command (at step 801), it reads the current sequence number output by each of the tiling units (at step 802), compares the read sequence numbers (at step 803), and selects the lowest sequence number (at step 804).

The primitive list reader 232 then starts processing the set of primitive lists corresponding to the lowest sequence number (at step 805), decodes a read command (at step 807), and outputs the decoded primitive (at step 808). This process is repeated until all of the primitives for the current draw call (or draw call part) have been decoded and output.

Then, when the primitive list reader 232 encounters a start draw call command (at step 806), it checks current sequence numbers output by the different tiling units again (at steps 802-804), and starts processing the set of primitive lists corresponding to the lowest sequence number (at step 805).

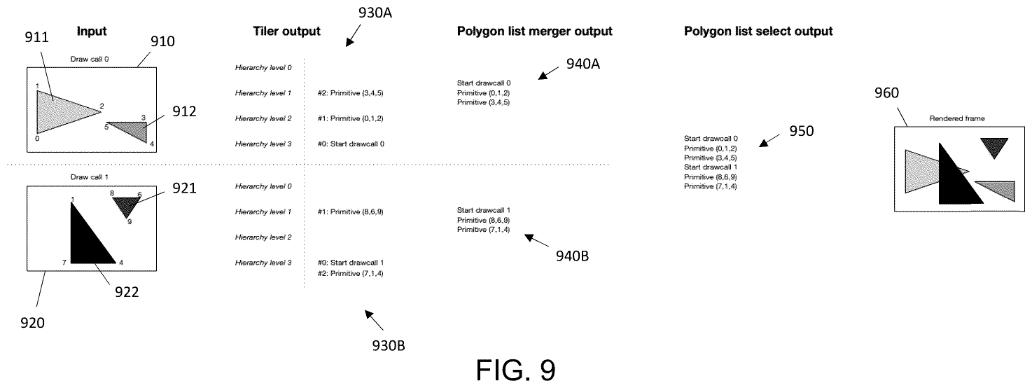

FIG. 9 illustrates an exemplary render output 960 that is generated by processing two draw calls 910, 920 in accordance with embodiments of the technology described herein. In this example, the first draw call 910 is to be processed before the second draw call 920. Furthermore, the first draw call 910 includes a first primitive 911, and a second primitive 912, to be processed in that order, and the second draw call 920 includes a first primitive 921, and a second primitive 922, to be processed in that order.

In this example, the tiler iterator 211 assigns a sequence number of “0” to the first draw call 910, and passes it to the first tiler 220A for processing. The tiler iterator 211 then assigns a sequence number of “1” to the second draw call 920, and passes it to the second tiler 220B for processing.

As shown in FIG. 9, the output of the first tiler 220A is a set of primitive lists 930A for different hierarchy levels, which are combined by the first primitive list merger 630A to produce a single primitive list 940A in which all of the commands for the first draw all 910 are listed in the desired order. Similarly, the output of the second tiler 220B is a set of primitive lists 930B for different hierarchy levels, which are combined by the second primitive list merger 630B to produce a single primitive list 940B in which all of the commands for the second draw all 920 are listed in the desired order.

When the primitive list selector 640 encounters a start draw call command, it compares the sequence numbers encoded in outputs 940A, 940B, determines that the first output 940A has the lowest sequence number, and so starts processing that output first. Then, once the first output 940A has been processed, and another start draw call command is encountered, the primitive list selector 640 determines that the second output 940B has the next lowest sequence number, and so starts processing that output. The primitive list selector 640 thereby outputs primitives and commands 950 in the originally desired order.

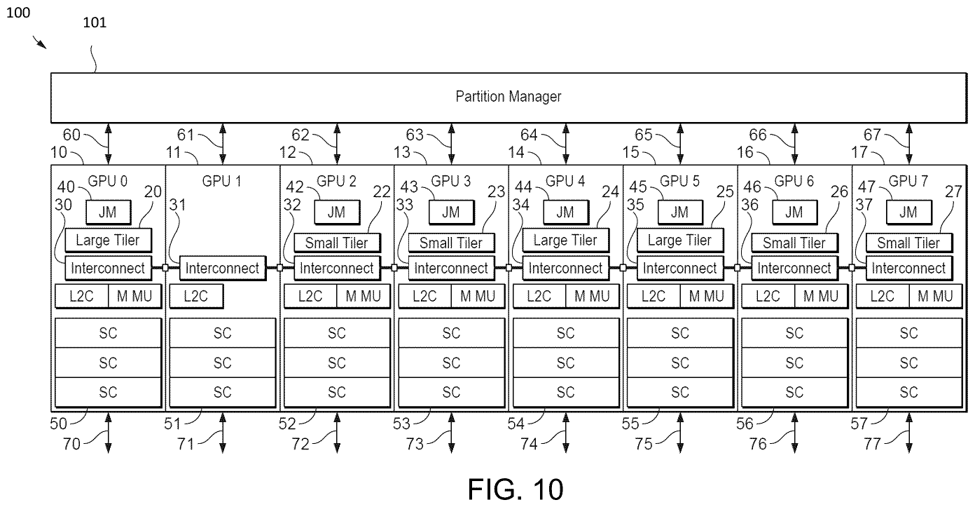

FIGS. 10 to 12 illustrate another embodiment of a graphics processor that has multiple tiling units. In this embodiment, the graphics processing system includes plural connected graphics processing units, and in which different sets of one or more of those graphics processing units, i.e. different “partitions”, can operate independently of each other. Such a graphics processing system may be particularly suited to automotive applications, for example. For example, a respective partition may be assigned for each of one or more of: a display screen for the main instrument console, an additional navigation and/or entertainment screen, and an Advanced Driver Assistance System (ADAS) of a vehicle, etc.

As shown in FIG. 10, in this embodiment, the graphics processor 100 includes eight connected tile-based graphics processing units (GPUs) 10-17. Other numbers of connected graphics processing units would be possible. It will also be appreciated here that FIG. 10 is only schematic, and the system may include other units and components not shown in FIG. 10.

In this system, the driver 9 sends commands and data for graphics processing tasks to the set of graphics processing units 100 for processing by some or all of the graphics processing units (GPUs) 10-17 to generate the desired data processing output. The partition manager 101 receives commands and data from the driver 9, and in response, configures the system appropriately to cause GPUs to operate in a standalone mode, or to be linked up with one or more other GPUs to work cooperatively on a given task.

In standalone mode, a GPU operates independently, e.g. under direct control from the host processor 1. In linked operation, one of the GPUs operates in a master mode and one or more other GPUs operate in a slave mode. In master mode the GPU controls the other GPU(s) operating in slave mode, and provides the software interface (the host processor interface) for the linked set of GPUs. In slave mode, the GPU operates under control of the master GPU.

This allows the set of graphics processing units 100 to be used in different situations, either as effectively plural separate GPUs executing different functions, or with the GPUs linked to execute a single function with higher performance. For example, one or more GPUs may operate as a first partition and generate a frame for display on a first display, e.g. under the control of a first application, while one or more other GPUs are operating as a second, independent partition that is generating a different frame for display on a different display, e.g. under the control of a second, different application. Alternatively, all of the GPUs may operate in combination as a single partition to generate the same frame for display on a single display, e.g. under the control of a single application.

As shown in FIG. 10, the partition manager 101 is connected to each GPU 10-17 via a respective configuration connection 60-67. The configuration connections 60-67 are used by the partition controller 101 to configure the GPUs 10-17 to operate in the desired modes of operation.

As shown in FIG. 10, GPUs include a respective (task) management circuit in the form of a job manager 40, 42-47 that can provide a software interface for a respective partition, and thus receive tasks (commands and data) from a driver 9, and distribute subtasks for execution to a respective tiling unit 20, 22-27 and/or to a respective set of shader cores 50-57. Each graphics processing unit in this embodiment comprises a set of three shader cores. Other numbers of shader cores would be possible.

As shown in FIG. 10, each graphics processing unit (GPU) 10-17 further includes a local L2 cache (L2C) which may store output data locally in a tile buffer. FIG. 10 shows each graphics processing unit (GPU) 10-17 having its own local L2 cache (L2C), but the graphics processing units (GPUs) 10-17 may all have access to the same shared L2 cache. Output data can be output from L2 cache (L2C) to a frame buffer in an external memory 6 for display, via a memory interface 70-77 under the control of a memory management unit (MMU).

As shown in FIG. 10, in the present embodiment, the eight graphics processing units 10-17 are “daisy-chained” together. Each graphics processing unit 10-17 comprises a respective interconnect 30-37 that is connected to the interconnect of the adjacent graphics processing unit(s) in the daisy-chain sequence.

The operating mode of a GPU 10-17 (standalone, master or slave mode) is set (enabled and disabled) by configuring it's interconnect 30-37 appropriately. For example, when a GPU is to operate in standalone mode, it's interconnect is configured to prevent communication with other graphics processing units. Correspondingly, when a GPU is to act as a master or slave, it's interconnect is configured to allow communication with one or two connected GPUs, as appropriate.

Moreover, when a GPU is operating in master or standalone mode, the GPU's job manager will operate to distribute tasks appropriately, and the GPU's tiling unit will operate to prepare primitive lists as appropriate. When a GPU is operating in slave mode, however, its job manager and tiling unit will typically be disabled.

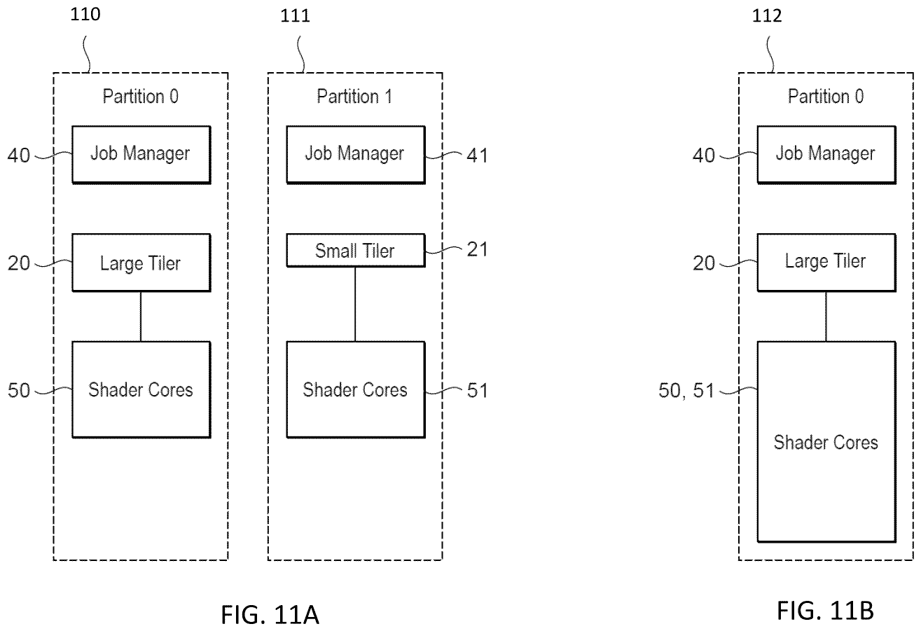

FIG. 11A illustrates an example in which two GPUs operate separately in standalone mode, and FIG. 11B illustrates an example in which the two GPUs operate together in linked mode.

As shown in FIG. 11A, in the standalone mode case, the first GPU acts as a first partition 110, and the second GPU acts as a second partition 111. The job manager 40, 41 of each GPU provides the software interface for the respective partition, and thus receives tasks (commands and data) from a driver, and divides a task given by the driver into subtasks and distributes the subtasks for execution to a respective tiling unit 20, 21 and set of shader cores 50, 51. Both job managers 40, 41 may receive tasks from the same driver 9, or there could be a different driver for each partition. As shown in FIG. 11A, in the standalone mode case, each tiling unit 20, 21 operates in combination with the respective set of shader cores 50, 51 of the respective GPU.

FIG. 11B illustrates the case where both GPUs act in combination as a single partition 112. In the present embodiment, the first GPU acts as the master (primary) graphics processing unit, while the second GPU acts as a slave (secondary) graphics processing unit. In this case, the job manager 40 of the first, master graphics processing unit provides the software interface for both GPUs, and thus receives tasks from a driver, and distributes subtasks to both sets of shader cores 50, 51. The job manager 41 of the second, slave GPU is accordingly disabled. Similarly, in this mode of operation, the tiling unit 20 of the first, master GPU will operate in combination with both sets of shader cores 50, 51, while the tiling unit 21 of the second, slave GPU is disabled.

In this example, the tiling unit 20 of the first GPU will accordingly need to be provided with a processing capacity that is sufficient to prepare primitive lists at a fast enough rate for operating in combination with both sets of shader cores 50, 51 combined, while the tiling unit 21 of the second GPU will only need to be provided with a processing capacity that is sufficient to prepare primitive lists at a fast enough rate for operating in combination with one of the sets of shader cores 51.

Accordingly, in this example, as shown in FIG. 11, the tiling unit 21 of the second GPU is provided with a smaller (maximum) processing (e.g. buffer) capacity than the tiling unit 20 of the first GPU. Similarly, in the embodiment shown in FIG. 10, the system includes three “large” tiling units 20, 24, 25, and four “small” tiling units 22, 23, 26, 27. Furthermore, one GPU 11 does not have a tiling unit, as it only ever operates in slave mode. Other arrangements are possible. For example, different distributions and/or sizes of tiling units could be used. For example, all of the GPUs could have tiling units that have the same processing capacity.

Further features of the system may be as described in WO 2022/096879.

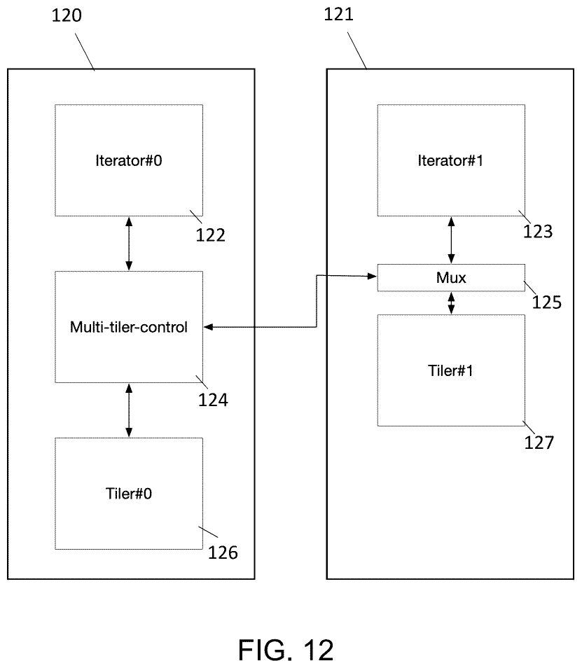

As illustrated in FIG. 12, in this embodiment plural, such as all, of the GPUs may be provided with a respective tiler iterator 122, 123, as well as a respective tiling unit 126, 127. Each tiler iterator may be part of the respective job manager, or could be a separate processing unit in communication with the job manager.

FIG. 12 illustrates the case where two GPUs 120, 121 are acting in combination as a single partition. In this case, the first GPU 120 acts as the master graphics processing unit, while the second GPU 121 acts as a slave graphics processing unit. In this case, the tiler iterator 122 of the first, master graphics processing unit distributes tiling tasks to both tiling units 126, 127, and each GPU has appropriate selector circuitry 124, 125 to facilitate this. The tiler iterator 123 of the second, slave GPU is disabled. Thus, in this case, plural tilers in the same partition can operate together. Other arrangements are possible.

It will be appreciated from the above that the technology described herein, in its embodiments at least, provides arrangements in which multiple tilers can cooperate to generate the same render output, while preserving the order of draw calls, and of primitives within a draw call. This is achieved, in the embodiments of the technology described herein at least, by dividing the tiling task for a render output between different tiling units on the basis of draw calls, maintaining information indicating the original order of the draw calls, and using the information to reconstruct the draw call order after the tiling stage.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A tiled-based graphics processor comprising:
a plurality of tiling units; and
an assigning circuit configured to, for each of one or more draw calls and/or draw call parts to be processed to generate a render output:
assign a tiling unit of the plurality of tiling units to process the respective draw call or draw call part; and
cause the assigned tiling unit to process the respective draw call or draw call part.

2. The tile-based graphics processor of claim 1, wherein the assigning circuit is configured to:
assign a first tiling unit of the plurality of tiling units to process a first draw call or draw call part to be processed to generate the render output, and cause the first tiling unit to process the first draw call or draw call part; and
assign a second, different tiling unit of the plurality of tiling units to process a second, different draw call or draw call part to be processed to generate the same render output, and cause the second tiling unit to process the second draw call or draw call part.

3. The tile-based graphics processor of claim 1, comprising a primitive list reader configured to read primitive lists prepared by each of the plurality of tiling units.

4. The tile-based graphics processor of claim 1, comprising a selecting circuit configured to select primitives from primitive lists prepared by one of the plurality of tiling units at a time.

5. The tile-based graphics processor of claim 4, wherein:
each of the plurality of tiling units is configured to output a set of primitives lists together with an associated identifier indicating a processing order in which the draw call or draw call part that was processed to prepare the set of primitive lists should be processed to generate the render output; and
the selecting circuit is configured to, in response to an indication of the end of a current draw call or draw call part or the start of a new draw call or draw call part, compare the identifiers associated with sets of primitive lists prepared by the plurality of tiling units, and select primitives from a set of primitive lists prepared by one of the plurality of tiling units based on the comparison.

6. The tile-based graphics processor of claim 1, wherein the assigning circuit is configured to assign to each of the one or more draw calls and/or draw call parts, an identifier indicating a processing order in which the respective draw call or draw call part should be processed to generate the render output.

7. The tile-based graphics processor of claim 5, wherein the identifier comprises a number that starts at an initial value for a first draw call or draw call part for a render output, and is incremented for each subsequent draw call or draw call part for the same render output.

8. The tile-based graphics processor of claim 1, comprising draw call splitting circuit configured to split draw calls into draw call parts, and provide the draw call parts to the assigning circuit.

9. The tile-based graphics processor of claim 8, wherein the draw call splitting circuit is configured to:
determine whether a draw call can be split into parts that can be processed independently of each other; and
when it is determined that a draw call can be split into parts that can be processed independently of each other, split the draw call into parts.

10. A method of operating a tiled-based graphics processor that comprises a plurality of tiling units; the method comprising:
for each of one or more draw calls and/or draw call parts to be processed to generate a render output:
assigning a tiling unit of the plurality of tiling units to process the respective draw call or draw call part; and
the assigned tiling unit processing the respective draw call or draw call part.

11. The method of claim 10, comprising:
assigning a first tiling unit of the plurality of tiling units to process a first draw call or draw call part to be processed to generate the render output, and the first tiling unit processing the first draw call or draw call part; and
assigning a second, different tiling unit of the plurality of tiling units to process a second, different draw call or draw call part to be processed to generate the same render output, and the second tiling unit processing the second draw call or draw call part.

12. The method of claim 10, comprising reading primitive lists prepared by each of the plurality of tiling units.

13. The method of claim 10, comprising selecting primitives from primitive lists prepared by one of the plurality of tiling units at a time.

14. The method of claim 13, comprising:
each of the plurality of tiling units outputting a set of primitives lists together with an associated identifier indicating a processing order in which the draw call or draw call part that was processed to prepare the set of primitive lists should be processed to generate the render output; and
in response to an indication of the end of a current draw call or draw call part or the start of a new draw call or draw call part, comparing the identifiers associated with sets of primitive lists prepared by the plurality of tiling units, and selecting primitives from a set of primitive lists prepared by one of the plurality of tiling units based on the comparison.

15. The method of claim 10, comprising:
assigning to each of the one or more draw calls and/or draw call parts, an identifier indicating a processing order in which the respective draw call or draw call part should be processed to generate the render output.

16. The method of claim 14, comprising assigning to each of the one or more draw calls and/or draw call parts, an identifier that comprises a number that starts at an initial value for a first draw call or draw call part for a render output, and is incremented for each subsequent draw call or draw call part for the same render output.

17. The method of claim 10, comprising splitting a draw call into draw call parts, and assigning tiling units to process the draw call parts.

18. The method of claim 17, comprising:
determining whether a draw call can be split into parts that can be processed independently of each other; and
when it is determined that a draw call can be split into parts that can be processed independently of each other, splitting the draw call into parts.

19. A non-transitory computer readable storage medium storing software code which when executing on a processor performs a method of operating a tiled-based graphics processor that comprises a plurality of tiling units; the method comprising:
for each of one or more draw calls and/or draw call parts to be processed to generate a render output:
assigning a tiling unit of the plurality of tiling units to process the respective draw call or draw call part; and
the assigned tiling unit processing the respective draw call or draw call part.
